(19) United States
(12) Patent Application Publication
(10) Pub. No.: US 2025/0233411 A1
(43) Pub. Date: Jul. 17, 2025

(54) POWER SUPPLY DEVICE

(71) Applicant: Quanta Computer Inc., Taoyuan City (TW)

(72) Inventor: Hsin-Chih KUO, Taoyuan City (TW)

(21) Appl. No.: 18/594,525

(22) Filed: Mar. 4, 2024

(30) Foreign Application Priority Data
Jan. 12, 2024 (TW) 113101335

(51) Int. Cl. H02J 1/10; H02J 7/00

(52) U.S. Cl. CPC H02J 1/122; H02J 7/0013; H02J 7/0063; H02J 7/00712

(57) ABSTRACT

A power supply device includes a first switch element, a second switch element, a third switch element, a fourth switch element, a fifth switch element, a sixth switch element, a switch transistor, a first battery element, and a second battery element. The first switch element selectively couples a first input node to a power node. The second switch element selectively couples a second input node to the power node. The switch transistor has a control terminal for receiving a control voltage, a first terminal coupled to an integrated node, and a second terminal coupled to a first output node. The third switch element selectively couples the integrated node to a first midway node. The fourth switch element selectively couples the integrated node to a second midway node. The first battery element and the second battery element are coupled to the first midway node and the second midway node.

### CROSS REFERENCE TO RELATED APPLICATIONS

This application claims priority of Taiwan Patent Application No. 113101335 filed on Jan. 12, 2024, the entirety of which is incorporated by reference herein.

### BACKGROUND OF THE INVENTION

### Field of the Invention

The disclosure generally relates to a power supply device, and more specifically, to a power supply device with high output stability.

### Description of the Related Art

If the AC (Alternating Current) power source or the battery element of a conventional power supply device is removed, an instant power shut-down event may occur, which may inconvenience the user. Accordingly, there is a need to propose a novel solution for solving this problem of the prior art.

### BRIEF SUMMARY OF THE INVENTION

In an exemplary embodiment, the invention is directed to a power supply device for providing electric power to a system end. The power supply device includes a first switch element, a second switch element, a third switch element, a fourth switch element, a fifth switch element, a sixth switch element, a charge circuit, a switch transistor, a first battery element, a second battery element, and a control circuit. The first switch element selectively couples a first input node to a power node. The second switch element selectively couples a second input node to the power node. The charge circuit is coupled between the power node and a first output node, and is configured to generate a control voltage. The switch transistor has a control terminal for receiving the control voltage, a first terminal coupled to an integrated node, and a second terminal coupled to the first output node. The third switch element selectively couples the integrated node to a first midway node. The fourth switch element selectively couples the integrated node to a second midway node. The first battery element is coupled to the first midway node. The second battery element is coupled to the second midway node. The fifth switch element selectively couples the first midway node to a second output node. The sixth switch element selectively couples the second midway node to the second output node. The control circuit is configured to control the first switch element, the second switch element, the third switch element, the fourth switch element, the fifth switch element, and the sixth switch element.

In some embodiments, the switch transistor is an NMOSFET (N-type Metal Oxide Semiconductor Field Effect Transistor).

In some embodiments, the power supply device further includes a first diode and a second diode. The first diode has an anode coupled to the first switch element, and a cathode coupled to the power node. The second diode has an anode coupled to the second switch element, and a cathode coupled to the power node.

In some embodiments, the power supply device further includes a third diode and a fourth diode. The third diode has an anode coupled to the integrated node, and a cathode coupled to the third switch element. The fourth diode has an anode coupled to the integrated node, and a cathode coupled to the fourth switch element.

In some embodiments, the power supply device further includes a fifth diode and a sixth diode. The fifth diode has an anode coupled to the fifth switch element, and a cathode coupled to the second output node. The sixth diode has an anode coupled to the sixth switch element, and a cathode coupled to the second output node.

In some embodiments, the power supply device further includes a seventh diode. The seventh diode has an anode coupled to the first output node, and a cathode coupled to the system end.

In some embodiments, the power supply device further includes a seventh switch element. The seventh switch element selectively couples the second output node to the system end. The seventh switch element is controlled by the control circuit.

In some embodiments, if the first input voltage at the first input node is lower than the first threshold voltage, the control circuit will force the second switch element to be closed. If the second input voltage at the second input node is lower than the first threshold voltage, the control circuit will force the first switch element to be closed.

In some embodiments, if the first midway voltage at the first midway node is lower than the second threshold voltage, the control circuit will force the sixth switch element to be closed. If the second midway voltage at the second midway node is lower than the second threshold voltage, the control circuit will force the fifth switch element to be closed.

In some embodiments, if the first output voltage at the first output node is higher than or equal to the third threshold voltage, the control circuit will force the seventh switch element to be opened. If the first output voltage at the first output node is lower than the third threshold voltage, the control circuit will force the seventh switch element to be closed.

### BRIEF DESCRIPTION OF DRAWINGS

The invention can be more fully understood by reading the subsequent detailed description and examples with references made to the accompanying drawings, wherein:

FIG. 1 is a diagram of a power supply device according to an embodiment of the invention; and

FIG. 2 is a diagram of a power supply device according to another embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

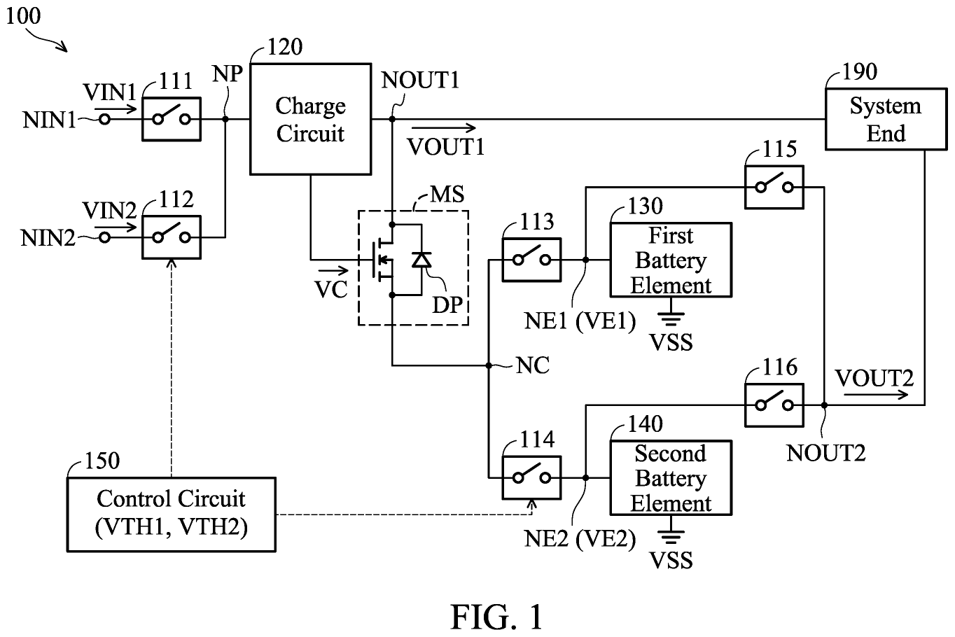

FIG. 1 is a diagram of a power supply device 100 according to an embodiment of the invention. As shown in FIG. 1, the power supply device 100 includes a first switch element 111, a second switch element 112, a third switch element 113, a fourth switch element 114, a fifth switch element 115, a sixth switch element 116, a charge circuit 120, a first battery element 130, a second battery element 140, a control circuit 150, and a switch transistor MS. It should be noted that the power supply device 100 may further include other components, such as a processor, a touch control module, a speaker, and/or a device housing, although they are not displayed in FIG. 1.

The power supply device 100 can provide electric power to a system end 190. For example, the system end 190 may be a tablet computer or a notebook computer, but it is not limited thereto. It should be understood that the system end 190 is an external device, which does not belong to any portion of the power supply device 100.

The first switch element 111 can selectively couple a first input node NIN1 to a power node NP. Specifically, the first switch element 111 has a first terminal coupled to the first input node NIN1, and a second terminal coupled to the power node NP. The first switch element 111 is controlled by the control circuit 150. For example, if the first switch element 111 is closed, it may couple the first input node NIN1 to the power node NP. Conversely, if the first switch element 111 is opened, it may not couple the first input node NIN1 to the power node NP.

In some embodiments, the first input node NIN1 is coupled to or decoupled from a first power adapter (not shown). For example, the first power adapter may be an AC (Alternating Current) adapter, but it is not limited thereto.

The second switch element 112 can selectively couple a second input node NIN2 to the power node NP. Specifically, the second switch element 112 has a first terminal coupled to the second input node NIN2, and a second terminal coupled to the power node NP. The second switch element 112 is controlled by the control circuit 150. For example, if the second switch element 112 is closed, it may couple the second input node NIN2 to the power node NP. Conversely, if the second switch element 112 is opened, it may not couple the second input node NIN2 to the power node NP.

In some embodiments, the second input node NIN2 is coupled to or decoupled from a second power adapter (not shown). For example, the second power adapter may be a USB (Universal Serial Bus) Type-C adapter, but it is not limited thereto.

The charge circuit 120 is coupled between the power node NP and a first output node NOUT1, and is configured to generate a control voltage VC. In some embodiments, the charge circuit 120 is a buck converter. In alternative embodiments, the charge circuit 120 is a buck-boost converter.

In some embodiments, the switch transistor MS is an NMOSFET (N-type Metal Oxide Semiconductor Field Effect Transistor). Specifically, the switch transistor MS has a control terminal (e.g., a gate) for receiving the control voltage VC, a first terminal (e.g., a source) coupled to an integrated node NC, and a second terminal (e.g., a drain) coupled to the first output node NOUT1. In addition, a body diode DP may be built in the switch transistor MS. The body diode DP has an anode coupled to the integrated node NC, and a cathode coupled to the first output node NOUT1.

In some embodiments, the charge circuit 120 usually outputs the control voltage VC with a high logic level (or a logic “1”) for enabling the switch transistor MS. In alternative embodiments, the charge circuit 120 outputs the control voltage VC with a low logic level (or a logic “0”) for disabling the switch transistor MS, and it is often used to prevent the corresponding battery element from being overcharged.

The third switch element 113 can selectively couple the integrated node NC to a first midway node NE1. Specifically, the third switch element 113 has a first terminal coupled to the integrated node NC, and a second terminal coupled to the first midway node NE1. The third switch element 113 is controlled by the control circuit 150. For example, if the third switch element 113 is closed, it may couple the integrated node NC to the first midway node NE1. Conversely, if the third switch element 113 is opened, it may not couple the integrated node NC to the first midway node NE1.

The fourth switch element 114 can selectively couple the integrated node NC to a second midway node NE2. Specifically, the fourth switch element 114 has a first terminal coupled to the integrated node NC, and a second terminal coupled to the second midway node NE2. The fourth switch element 114 is controlled by the control circuit 150. For example, if the fourth switch element 114 is closed, it may couple the integrated node NC to the second midway node NE2. Conversely, if the fourth switch element 114 is opened, it may not couple the integrated node NC to the second midway node NE2.

The first battery element 130 and the second battery element 140 are configured to store electric energy, and they are both coupled to a ground voltage VSS. In addition, the first battery element 130 is also coupled to the first midway node NE1, and the second battery element 140 is also coupled to second midway node NE2. The types and styles of the first battery element 130 and the second battery element 140 are not limited in the invention.

The fifth switch element 115 can selectively couple the first midway node NE1 to a second output node NOUT2. Specifically, the fifth switch element 115 has a first terminal coupled to the first midway node NE1, and a second terminal coupled to the second output node NOUT2. The fifth switch element 115 is controlled by the control circuit 150. For example, if the fifth switch element 115 is closed, it may couple the first midway node NE1 to the second output node NOUT2. Conversely, if the fifth switch element 115 is opened, it may not couple the first midway node NE1 to the second output node NOUT2.

The sixth switch element 116 can selectively couple the second midway node NE2 to the second output node NOUT2. Specifically, the sixth switch element 116 has a first terminal coupled to the second midway node NE2, and a second terminal coupled to the second output node NOUT2. The sixth switch element 116 is controlled by the control circuit 150. For example, if the sixth switch element 116 is closed, it may couple the second midway node NE2 to the second output node NOUT2. Conversely, if the sixth switch element 116 is opened, it may not couple the second midway node NE2 to the second output node NOUT2.

The control circuit 150 is coupled to the first switch element 111, the second switch element 112, the third switch element 113, the fourth switch element 114, the fifth switch element 115, and the sixth switch element 116. For example, the control circuit 150 may be implemented with an MCU (Microcontroller Unit), and it may include a detection module and a comparison module (not shown). Specifically, the operations of the control circuit 150 will be described as follows.

In some embodiments, the control circuit 150 can monitor a first input voltage VIN1 at the first input node NIN1 and a second input voltage VIN2 at the second input node NIN2. Next, the control circuit 150 can compare both the first input voltage VIN1 and the second input voltage VIN2 with a first threshold voltage VTH1, and control the operational states of the first switch element 111 and the second switch element 112 based on the comparison results. For example, the first threshold voltage VTH1 may be about 7V, 8V or 17V, but it is not limited thereto. Initially, the first switch element 111 and the second switch element 112 may be closed, and then they may be controlled (or opened) by the control circuit 150 according to different requirements. Specifically, if the first input voltage VIN1 is lower than the first threshold voltage VTH1, the control circuit 150 can force the second switch element 112 to be closed. Conversely, if the second input voltage VIN2 is lower than the first threshold voltage VTH1, the control circuit 150 can force the first switch element 111 to be closed. With such a design, even if one of the first power adapter and the second power adapter is suddenly removed, the power supply device 100 will still receive the external input energy from the other of the first power adapter and the second power adapter.

In some embodiments, the control circuit 150 can freely control the third switch element 113 and the fourth switch element 114, so as to perform a charge operation on the first battery element 130, the second battery element 140, or a combination thereof.

In some embodiments, the control circuit 150 can monitor the first midway voltage VE1 at the first midway node NE1 and the second midway voltage VE2 at the second midway node NE2. Next, the control circuit 150 can compare both the first midway voltage VE1 and the second midway voltage VE2 with a second threshold voltage VTH2, and control the operational states of the fifth switch element 115 and the sixth switch element 116 based on the comparison results. For example, the second threshold voltage VTH2 may be about 7V or 8V, but it is not limited thereto. Initially, the fifth switch element 115 and the sixth switch element 116 may be closed, and then they may be controlled (or opened) by the control circuit 150 according to different requirements. Specifically, if the first midway voltage VE1 is lower than the second threshold voltage VTH2, the control circuit 150 can force the sixth switch element 116 to be closed. Conversely, if the second midway voltage VE2 is lower than the second threshold voltage VTH2, the control circuit 150 can force the fifth switch element 115 to be closed. With such a design, even if one of the first battery element 130 and the second battery element 140 is suddenly disabled, removed, or run out of power, the other of the first battery element 130 and the second battery element 140 will still provide backup power to the power supply device 100.

Generally, the power supply device 100 may operate in either an AC mode or a DC (Direct Current) mode, and they will be described in detailed over the following embodiments.

In the AC mode, if the charge circuit 120 receives the first input voltage VIN1 from the first power adapter or the second input voltage VIN2 from the second power adapter, the system end 190 will be supplied by the first output voltage VOUT1 at the first output node NOUT1. At this time, the first output voltage VOUT1 can be generated by the charge circuit 120 according to the first input voltage VIN1 or the second input voltage VIN2. Furthermore, the first battery element 130 or the second battery element 140 can be charged by using the first output voltage VOUT1.

In the DC mode, if both the first power adapter and the second power adapter are removed, the system end 190 will be supplied by the second output voltage VOUT2 at the second output node NOUT2. At this time, the first battery element 130 can provide the first midway voltage VE1, and the second battery element 140 can provide the second midway voltage VE2. By appropriately controlling the fifth switch element 115 and the sixth switch element 116, any of the first midway voltage VE1 and the second midway voltage VE2 can be used as the second output voltage VOUT2.

With the design of the invention, even if the corresponding power adapter or the corresponding battery element is disabled or temporarily removed, the power supply device 100 will normally provide electric power to the system end 190. Also, an auxiliary current path can be formed by the body diode DP of the switch transistor MS. In other words, since the power supply device 100 of the invention provides very high output stability, it can significantly reduce the probability of the system end 190 being unexpectedly shut down. It should be understood that the invention is not limited to the configuration in FIG. 1. In alternative embodiments, the power supply device 100 includes more switch elements and more battery elements, which may be used together with more power adapters (not shown).

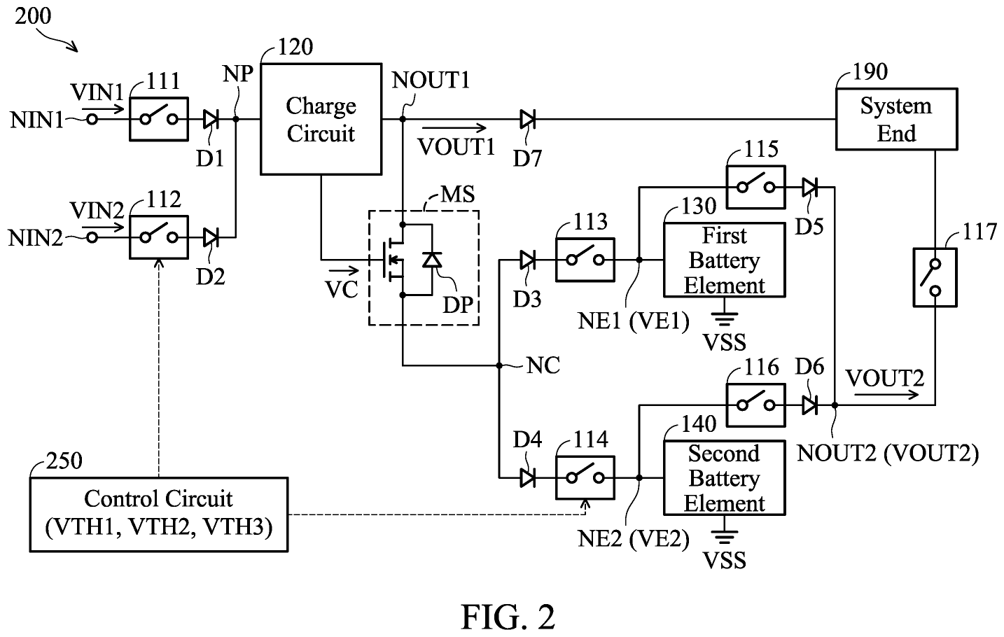

FIG. 2 is a diagram of a power supply device 200 according to another embodiment of the invention. FIG. 2 is similar to FIG. 1. In the embodiment of FIG. 2, the power supply device 200 further includes a first diode D1, a second diode D2, a third diode D3, a fourth diode D4, a fifth diode D5, a sixth diode D6, and a seventh diode D7.

The first diode D1 has an anode coupled to the second terminal of the first switch element 111, and a cathode coupled to the power node NP. The second diode D2 has an anode coupled to the second terminal of the second switch element 112, and a cathode coupled to the power node NP. According to practical measurements, the first diode D1 and the second diode D2 are configured to increase the isolation between the first input node NIN1 and the second input node NIN2.

The third diode D3 has an anode coupled to the integrated node NC, and a cathode coupled to the first terminal of the third switch element 113. The fourth diode D4 has an anode coupled to the integrated node NC, and a cathode coupled to the first terminal of the fourth switch element 114. According to practical measurements, the third diode D3 and the fourth diode D4 are configured to prevent an abnormal charge event from occurring between the first battery element 130 and the second battery element 140.

The fifth diode D5 has an anode coupled to the second terminal of the fifth switch element 115, and a cathode coupled to the second output node NOUT2. The sixth diode D6 has an anode coupled to the second terminal of the sixth switch element 116, and a cathode coupled to the second output node NOUT2. According to practical measurements, the fifth diode D5 and the sixth diode D6 are configured to prevent an abnormal discharge event from occurring between the first battery element 130 and the second battery element 140.

The seventh diode D7 has an anode coupled to the first output node NOUT1, and a cathode coupled to the system end 190. According to practical measurements, the seventh diode D7 is configured to prevent a variety of currents of the system end 190 from flowing back to the power supply device 200.

In addition, the power supply device 200 further includes a seventh switch element 117. The seventh switch element 117 can selectively couple the second output node NOUT2 to the system end 190. Specifically, the seventh switch element 117 has a first terminal coupled to the second output node NOUT2, and a second terminal coupled to the system end 190. The seventh switch element 117 is controlled by a control circuit 250 of the power supply device 200. For example, if the seventh switch element 117 is closed, it may couple the second output node NOUT2 to the system end 190. Conversely, if the seventh switch element 117 is opened, it may not couple the second output node NOUT2 to the system end 190.

In some embodiments, the control circuit 250 can monitor the first output voltage VOUT1 at the first output node NOUT1. Next, the control circuit 250 can compare the first output voltage VOUT1 with a third threshold voltage VTH3, and control the operational state of the seventh switch element 117 based on the comparison result. For example, the third threshold voltage VTH3 may be about 7V or 8V, but it is not limited thereto. Initially, the seventh switch element 117 may be closed, and then it may be controlled (or opened) by the control circuit 250 according to different requirements. Specifically, the first output voltage VOUT1 is higher than or equal to the third threshold voltage VTH3, the control circuit 250 can force the seventh switch element 117 to be opened. Conversely, if the first output voltage VOUT1 is lower than the third threshold voltage VTH3, the control circuit 250 can force the seventh switch element 117 to be closed. With such a design, even if both the first power adapter and the second power adapter are suddenly removed, the power supply device 200 will immediately use the first battery element 130 or the second battery element 140 to provide backup electric power to the system end 190. According to practical measurements, the seventh switch element 117 is configured to prevent the AC mode and the DC mode of the power supply device 200 from being interfering with each other.

The invention proposes a novel power supply device. According to practical measurements, the power supply device using the aforementioned design has at least the advantages of supporting the multi-input power source and enhancing the output stability, and therefore it is suitable for application in a variety of devices.

Note that the above voltages, currents, resistances, inductances, capacitances and other element parameters are not limitations of the invention. A designer can adjust these settings according to different requirements. The power supply device of the invention is not limited to the configurations of FIGS. 1-2. The invention may merely include any one or more features of any one or more embodiments of FIGS. 1-2. In other words, not all of the features displayed in the figures should be implemented in the power supply device of the invention. Although the embodiments of the invention use MOSFET as examples, the invention is not limited thereto, and those skilled in the art may use other types of transistors, such as BJT (Bipolar Junction Transistor), JFET (Junction Gate Field Effect Transistor), FinFET (Fin Field Effect Transistor), etc., without affecting the performance of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered exemplary only, with the true scope of the disclosed embodiments being indicated by the following claims and their equivalents.

What is claimed is:

1. A power supply device for providing electric power to a system end, comprising:
a first switch element, selectively coupling a first input node to a power node;
a second switch element, selectively coupling a second input node to the power node;
a charge circuit, coupled between the power node and a first output node, and generating a control voltage;
a switch transistor, wherein the switch transistor has a control terminal for receiving the control voltage, a first terminal coupled to an integrated node, and a second terminal coupled to the first output node;
a third switch element, selectively coupling the integrated node to a first midway node;
a fourth switch element, selectively coupling the integrated node to a second midway node;
a first battery element, coupled to the first midway node;
a second battery element, coupled to the second midway node;
a fifth switch element, selectively coupling the first midway node to a second output node;
a sixth switch element, selectively coupling the second midway node to the second output node; and
a control circuit, controlling the first switch element, the second switch element, the third switch element, the fourth switch element, the fifth switch element, and the sixth switch element.

2. The power supply device as claimed in claim 1, wherein the switch transistor is an NMOSFET (N-type Metal Oxide Semiconductor Field Effect Transistor).

3. The power supply device as claimed in claim 1, further comprising:
a first diode, wherein the first diode has an anode coupled to the first switch element, and a cathode coupled to the power node; and
a second diode, wherein the second diode has an anode coupled to the second switch element, and a cathode coupled to the power node.

4. The power supply device as claimed in claim 3, further comprising:
a third diode, wherein the third diode has an anode coupled to the integrated node, and a cathode coupled to the third switch element; and
a fourth diode, wherein the fourth diode has an anode coupled to the integrated node, and a cathode coupled to the fourth switch element.

5. The power supply device as claimed in claim 4, further comprising:
a fifth diode, wherein the fifth diode has an anode coupled to the fifth switch element, and a cathode coupled to the second output node; and
a sixth diode, wherein the sixth diode has an anode coupled to the sixth switch element, and a cathode coupled to the second output node.

6. The power supply device as claimed in claim 5, further comprising:
a seventh diode, wherein the seventh diode has an anode coupled to the first output node, and a cathode coupled to the system end.

7. The power supply device as claimed in claim 1, further comprising:
a seventh switch element, selectively coupling the second output node to the system end, wherein the seventh switch element is controlled by the control circuit.

8. The power supply device as claimed in claim 7, wherein if a first input voltage at the first input node is lower than a first threshold voltage, the control circuit forces the second switch element to be closed, and if a second input voltage at the second input node is lower than the first threshold voltage, the control circuit forces the first switch element to be closed.

9. The power supply device as claimed in claim 8, wherein if a first midway voltage at the first midway node is lower than a second threshold voltage, the control circuit forces the sixth switch element to be closed, and if a second midway voltage at the second midway node is lower than the second threshold voltage, the control circuit forces the fifth switch element to be closed.

10. The power supply device as claimed in claim 9, wherein if a first output voltage at the first output node is higher than or equal to a third threshold voltage, the control circuit forces the seventh switch element to be opened, and if the first output voltage at the first output node is lower than the third threshold voltage, the control circuit forces the seventh switch element to be closed.
